(19) United States
(12) Patent Application Publication
(10) Pub. No.: US 2011/0168057 A1
(43) Pub. Date: Jul. 14, 2011

(54) MINERAL BLENDS FOR LOW-TITANIA COATINGS

(75) Inventors: David Gittins, Truro (GB); Martyn Gadsdon, Truro (GB); David Skuse, Truro (GB)

(73) Assignee: Imerys Minerals, Limited, Par, Cornwall (GB)

(21) Appl. No.: 13/119,586

(22) PCT Filed: Jun. 8, 2010
(86) PCT No.: PCT/IB10/01485

§ 371 Date: Mar. 17, 2011

Related U.S. Application Data
(60) Provisional application No. 61/185,108, filed on Jun. 8, 2009.

(51) Int. Cl. C09D 1/00

(52) U.S. Cl. 106/286.4

(57) ABSTRACT

A coating composition may include a coating vehicle, kaolin having a d₅₀ of not more than 2 microns, alkaline earth metal carbonate having a d₅₀ of not more than 2 microns, and not more than 10% by weight titanium dioxide relative to the weight of the coating composition. A method for improving opacity of a coating composition may include adding kaolin and alkaline earth metal carbonate to the coating composition. A method for reducing titanium dioxide content of a coating composition and at least substantially maintaining opacity of the coating may include adding fine kaolin and fine alkaline earth metal carbonate to the coating composition, wherein a volume concentration ratio of the fine kaolin to the fine alkaline earth metal carbonate ranges between 0.5:1 and 10:1.

### CLAIM OF PRIORITY/INCORPORATION BY REFERENCE

This PCT International Application claims the right of priority to, and hereby incorporates by reference herein in its entirety, U.S. Provisional Patent Application No. 61/185,108, filed Jun. 8, 2009, and also claims the benefits of any rights of priority that may be available to that application.

### FIELD OF THE INVENTION

The present disclosure relates to enhancing the opacity of coatings that contain a relatively low level of titanium dioxide via use of kaolin and alkaline earth metal carbonate blends.

### BACKGROUND OF THE INVENTION

Coatings such as, for example, paints (oil- and water-based paints), sealants, architectural coatings, and industrial coatings (e.g., coatings other than paper coatings), may be used to improve the visual characteristics of a substrate and/or protect a substrate. Titanium dioxide (TiO₂) may be used as a filler or pigment for coating compositions due to its advantageous scattering and opacifying characteristics. However, titanium dioxide is expensive, and thus, it may be desirable to replace some or all of the titanium dioxide in such coating compositions in order to reduce costs. In addition, increased concern over global warming and greenhouse gases has led to increased customer demand for products having a lower carbon footprint. Titanium dioxide has a relatively high carbon footprint, and thus, it may be desirable to reduce the quantity of titanium dioxide used in coatings such as paints, thereby providing production of more environmentally friendly coatings.

Titanium dioxide may be used as a broadband and high efficiency optical scattering pigment to provide opacity in paint films and other coatings. This may allow for a reduced thickness of paints and other coatings, while still providing desired opacity and hiding capability. However, as levels of titanium dioxide in a paints or other coatings are reduced, the opacity and hiding capability of the paint film may be adversely affected. This may result in the need to apply thicker coats of paint or extra coats of paint to effectively cover a substrate, which may result in offsetting some or all of the relative benefits of reducing the titanium dioxide content.

Thus, it may be desirable to provide coating compositions that permit reduced titanium dioxide content, while still providing effective coating of substrates.

### SUMMARY OF THE INVENTION

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to a coating composition including a coating vehicle, kaolin having a d₅₀ of not more than 2 microns, alkaline earth metal carbonate having a d₅₀ of not more than 2 microns, and not more than 10% by weight titanium dioxide relative to the weight of the coating composition. As used herein, the term “coating vehicle” refers to the liquid components of a coating composition, such as, for example, solvents, binders, and other additives, such as, for example, dispersants, thickeners, defoamers, biocides, and the like.

According to a further aspect, a method for improving opacity of a coating composition includes adding kaolin and alkaline earth metal carbonate to the coating composition. The kaolin may have a d₅₀ of not more than 2 microns, the alkaline earth metal carbonate may have a d₅₀ of not more than 2 microns, and the coating composition may include not more than 10% by weight titanium dioxide relative to the weight of the coating composition.

According to a further aspect, the disclosure relates to a method for reducing titanium dioxide content of a coating composition and at least substantially maintaining opacity of the coating. The method may include adding fine kaolin and fine alkaline earth metal carbonate to the coating composition, wherein a volume concentration ratio of the fine kaolin to the fine alkaline earth metal carbonate ranges between 0.5:1 and 10:1.

Exemplary objects and advantages of the invention will be set forth in part in the description which follows, or may be learned by practice of the exemplary embodiments. It is to be understood that both the foregoing general description and the following detailed description are exemplary and explanatory only and are not restrictive of the invention, as claimed.

The accompanying drawings, which are incorporated in and constitute a part of this specification, illustrate exemplary embodiments of the invention and together with the description, may serve to explain some principles of the invention.

### BRIEF DESCRIPTION OF THE FIGURES

FIG. 1 is a graph of opacity (%) vs. kaolin-carbonate concentration (% volume concentration) for TiO₂ at 0%, 3.5%, 10%, and 15% volume concentration, where the alkaline earth metal carbonate includes an exemplary ground calcium carbonate (GCC);

FIG. 2 is a graph of Lightness (L) vs. volume ratio of exemplary blends of fine kaolin and exemplary alkaline earth metal carbonate; and

FIG. 3 is a graph of and Yellowness (b) vs. volume ratio of exemplary blends of fine kaolin and exemplary alkaline earth metal carbonate.

### DESCRIPTION OF EXEMPLARY EMBODIMENTS

Compositions and methods according to exemplary aspects of the disclosure may allow inorganic particulate materials, and, particularly, blends of kaolin (e.g., hydrous kaolin) and alkaline earth metal carbonate (e.g., hydrous alkaline earth metal carbonate) may be employed as an extender in coatings, such as, for example, paint compositions, to provide an opacity which approaches, matches, or even exceeds that which may be achieved using more expensive extenders, such as, for example, calcined and/or chemically aggregated kaolins. Furthermore, this opacity improvement may be obtained without other disadvantages sometimes associated with the use of calcined and/or chemically aggregated kaolins.

Particle size characteristics described herein are measured via sedimentation of the particulate material in a fully dispersed condition in an aqueous medium using a Sedigraph 5100 particle size analyzer, supplied by Micromeritics Instruments Corporation, Norcross, Ga., USA. The Sedigraph 5100 provides measurements and a plot of the cumulative percentage by weight of particles having a size, referred to in the art as the “equivalent spherical diameter” (esd).

According to some exemplary embodiments, fine kaolin and fine alkaline earth metal carbonate blends may be used to enhance opacity of dry coatings containing a low level of titanium dioxide, for example, less than about 10% by weight titanium dioxide. For example, a coating formulation may contain less than about 10% titanium dioxide, such as, for example, less than about 8%, such as less than about 6%, such as less than about 4%, such as less than about 2%, or even about 0%, and a fine kaolin to fine calcium carbonate volume concentration ratio ranging between about 0.5:1 and about 10:1, such as, for example, ranging between about 0.7:1 to about 5:1, or about 1:1 to about 3:1.

According to some embodiments, the fine kaolin may include, or constitute, a fine kaolin composition, such as, for example, that marketed by Imerys Minerals Ltd. under the trade name SUPREME™. SUPREME™ has a particle size of 77% less than 1 micron.

Further, according to some embodiments, alkaline earth metal carbonate may include, for example, one or more of precipitated calcium carbonate (PCC), ground calcium carbonate (GCC), dolomite, limestone, chalk, marble, barium carbonate, magnesium carbonate, and other alkaline earth metal carbonates known to those skilled in the art. For example, the alkaline earth metal carbonate may include, or constitute, a fine calcium carbonate composition marketed by Imerys Minerals Ltd. under the trade name CARBOPAQUE™. CARBOPAQUE™ has a particle size of 94% less than 2 microns and a mean particle size of 0.7 micron.

According to some embodiments, the fine kaolin component may have a top particle size (d₉₀) of less than about 5 microns (μm), such as, for example, less than about 2 μm. According to some embodiments, the fine kaolin component may have a median particle size (d₅₀) of less than about 2 μm, such as, for example, less than about 1 μm, such as less than about 0.75 μm, such as less than about 0.5 μm. According to some embodiments, the fine kaolin component may have a median particle size (d₅₀) ranging from about 0.1 μm to about 1 μm, such as, for example, from about 0.25 μm to about 0.75 μm, such as from about 0.3 μm to 0.5 μm. According to some embodiments, the fine kaolin component may have a steepness (defined as d₃₀/d₇₀×100) ranging from about 35 to about 60, such as, for example, from about 40 to about 50, such as from about 45 to 50.

According to some embodiments, the alkaline earth metal carbonate (e.g., a fine alkaline earth metal carbonate, such as, for example, fine GCC) may have a top particle size (d₉₀) of less than about 5 μm, such as, for example, less than about 2 μm. In another aspect, the alkaline earth metal carbonate may component may have a median particle size (d₅₀) of less than about 2 μm, such as, for example, less than about 1 μm, such as less than about 0.75 μm, such as less than about 0.5 μm. In a further embodiment, the alkaline earth metal carbonate (e.g., GCC) may have a median particle size (d₅₀) ranging from about 0.1 μm to about 1 μm, such as, for example, from about 0.25 μm to about 0.75 μm, such as from about 0.3 microns to 0.5 microns. According to some embodiments, the alkaline earth metal carbonate may include one or more of PCC, GCC, dolomite, limestone, chalk, marble, barium carbonate, magnesium carbonate, and other alkaline earth metal carbonates known to those skilled in the art.

According to some embodiments, the alkaline earth metal carbonate (e.g., a fine alkaline earth metal carbonate) may have a steepness (defined as d₃₀/d₇₀×100) ranging from 20 to 80. According to some embodiments, the alkaline earth metal carbonate may include GCC (including, for example, marble, chalk, dolomite and/or limestone) having a steepness ranging from about 20 to about 40, such as, for example, from about 25 to about 35, such as from about 30 to about 35. According to some embodiments, the alkaline earth metal carbonate may include GCC (including, for example, marble, chalk, dolomite and/or limestone) having a steepness ranging from about 40 to about 50, such as, for example, from about 40 to 55. According to some embodiments, the alkaline earth metal carbonate may include PCC having a steepness ranging from about 40 to about 60, such as, for example, from about 50 to about 60.

According to some embodiments, blends of fine kaolin and alkaline earth metal carbonate may be added to the composition as dry components and/or in slurry form. For example, if added in slurry form, the exemplary blend could comprise or constitute between about 30% and about 80% by weight of the composition, such as, for example, between about 65% and about 75% by weight, such as about 70% by weight.

According to some embodiments, the fine kaolin may have an oil absorption ranging from between about 20 g/100 g and about 100 g/100 g, such as, for example, between about 40 g/100 g and about 60 g/100 g, such as between about 45 g/100 g and about 50 g/100 g. According to some embodiments, the alkaline earth metal carbonate may have an oil absorption ranging between about 10 g/100 g and about 40 g/100 g, such as, for example, between about 15 g/100 g and about 30 g/100 g, such as between about 18 g/100 g and about 25 g/100 g. For example, according to some embodiments, a dry blend of fine kaolin and alkaline earth metal carbonate may have an oil absorption ranging between about 20 g/100 g and about 100 g/100 g, such as, for example, between about 25 g/100 g and about 50 g/100 g, such as between about 30 g/100 g and about 40 g/100 g.

According to some embodiments, a matting agent may be included in the blend of fine kaolin and alkaline earth metal carbonate. For example, a matting agent marketed by World Minerals under the trade name OPTIMAT™ (e.g., OPTIMAT 2550™), a matting agent that includes perlite, may be added to the blend. For example, the matting agent may range from about 0.1% to about 5% by weight of the coating composition, such as for example, from about 0.1% to about 3% by weight, for example, from about 0.1% to about 2% by weight (e.g., about 2% by weight).

It is hypothesized by the inventors that for coatings, such as, for example, paints, as titanium dioxide levels are reduced to, for example, less than 10% by weight of the paint composition, the efficiency of scattering from air voids becomes more important. The efficiency of optical scattering provided by the air voids may be related to the size and/or shape of the air voids, as well as their number and/or density. Therefore, it is believed that by manipulating, for example, controlling and/or optimizing, the size of the air voids, their scattering efficiency may be improved (e.g., optimized) and/or the coating (e.g., paint) may achieve an improved (e.g., optimum) opacity for a given pigment volume concentration (PVC).

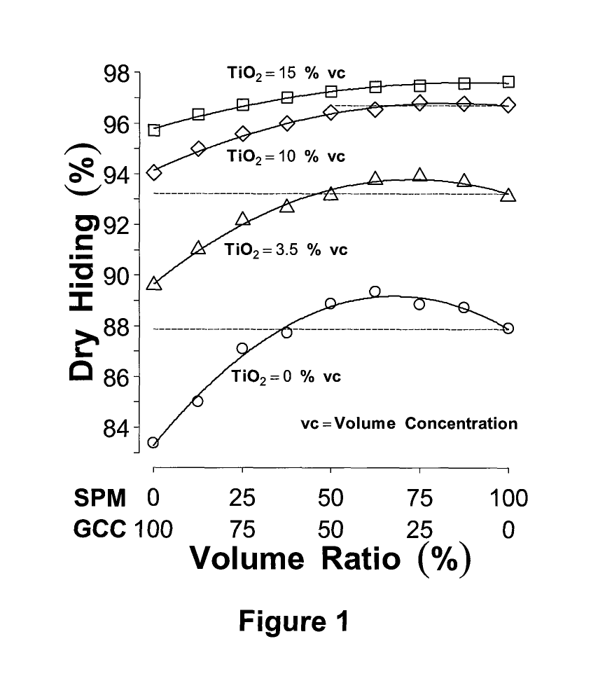

It is hypothesized by the inventors that fine kaolin particles in coatings, such as, for example, paint films, may act as effective spacers for titanium dioxide particles, thereby possibly increasing the scattering efficiency of a titanium dioxide pigment. For example, FIG. 1 shows the effective spacing of kaolin with respect to a fine carbonate, which is generally believed to space titanium dioxide (TiO₂) poorly, by plotting the opacity (i.e., where 100% opacity is completely opaque and 0% opacity is completely transparent) as a function of the relative proportions of two mineral extenders—kaolin and calcium carbonate. FIG. 1 is plotted for a constant total pigment volume concentration (PVC) of 73.52%, with 60.32% of this comprising titanium dioxide, kaolin, and calcium carbonate particles, with FIG. 1 showing the results for a titanium dioxide level equaling 0%, 3.5%, 10% and 15% by weight. As shown in FIG. 1, the kaolin particles appear to be acting as an efficient spacer for the titanium dioxide particles, for example, because the opacity gradually increases as the relative proportion of kaolin particles increases. As may be deduced from FIG. 1, there may be a synergistic effect between the fine kaolin particles and the fine alkaline earth metal carbonate particles that improves (e.g., optimizes) the size distribution of the air voids, such that the paint film is more opaque for an appropriate ratio of the two mineral extenders than for either of the pure kaolin or pure carbonate formulations.

Thus, according to some exemplary embodiments, fine kaolin and fine alkaline earth metal carbonate (e.g., calcium carbonate) blends may be used to enhance the opacity of a dry coating that contains a low level of titanium dioxide. For example, there may be a synergistic response between fine kaolin and fine carbonate that may be relatively stronger at lower titanium dioxide levels (e.g., zero percent) than in “typical” paint formulations and/or other coating formulations.

The Table below provides the composition of the paint tested for which the results are shown in FIG. 1 for the formulation in which the titanium dioxide has a volume concentration of 0%.

TABLE

| | Weight % |
|---|---|
| Fine kaolin | 23.82 |
| Fine CC | 14.73 |
| Optimat 2550 (perlite-based matting agent) | 2.02 |
| Luzenac OXO (talc) | 6.19 |
| Natrosol 250MR (thickener) | 0.34 |
| 28% Ammonia Solution | 0.10 |
| Dispex N40 (dispersant) | 0.47 |
| Foamaster NDW (defoamer) | 0.15 |
| Water | 38.89 |
| Mowilith LDM 1871 (binder) | 13.09 |
| Rocima 564 (biocide) | 0.19 |
| Total | 100.00 |

| | | | |
|---|---|---|---|
| % Solids | 54.41 | Vol. Solids | 34.99 |
| Paint SG (g/cm³) | 1.424 | TiO2vc | 0.00 |
| | | Fine kaolin | 37.70 |
| | | vc | |
| | | Fine CC vc | 22.62 |
| | | Luzenac vc | 9.19 |
| | | O'mat 2550 | 4.00 |
| | | vc | |
| | | “blend” pvc | 60.31 |
| | | TOTAL pvc | 73.51 |

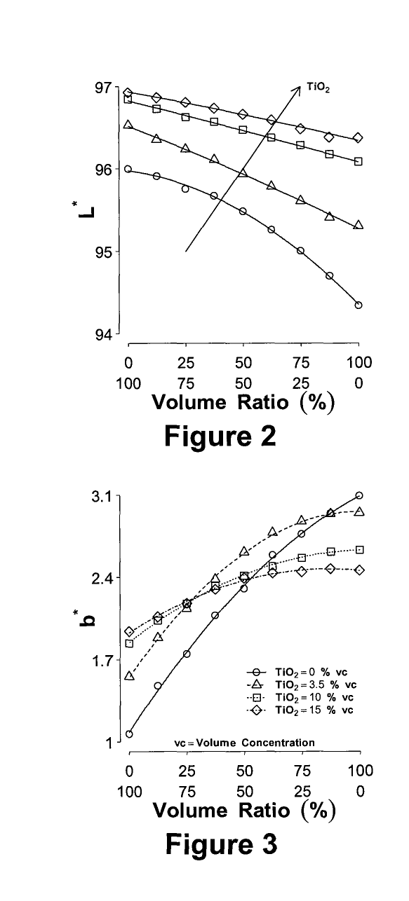

Referring to FIG. 2, it shows a graph of the effects on Whiteness (L) of an exemplary paint composition at different blend ratios of fine kaolin to carbonate. FIG. 4 shows a graph of the effects on Yellowness (b) of an exemplary paint composition at different blend ratios of fine kaolin to carbonate. As shown in FIGS. 2 and 3, adding relatively more carbonate increases Whiteness, and adding relatively more kaolin increases Yellowness.

Other embodiments of the invention will be apparent to those skilled in the art from consideration of the specification and practice of the exemplary embodiments disclosed herein. It is intended that the specification and examples be considered as exemplary only, with a true scope and spirit of the invention being indicated by the following claims.

1-51. (canceled)

52. A paint or architectural coating composition comprising:
a coating vehicle;
kaolin having a d₅₀ of not more than 2 microns;
alkaline earth metal carbonate having a d₅₀ of not more than 2 microns; and
not more than 10% by weight titanium dioxide relative to the weight of the paint composition.

53. The composition of claim 52, wherein the alkaline earth metal carbonate comprises at least one of calcium carbonate, dolomite, limestone, chalk, marble, barium carbonate, and magnesium carbonate.

54. The composition of claim 53, wherein the alkaline earth metal carbonate comprises calcium carbonate.

55. The composition of claim 54, wherein the calcium carbonate comprises ground calcium carbonate.

56. The composition of claim 54, wherein the calcium carbonate comprises precipitated calcium carbonate.

57. The composition of claim 52, wherein the coating composition comprises between 1% and 10% by weight titanium dioxide relative to the weight of the paint composition.

58. The composition of claim 52, wherein the coating composition comprises less than about 8% by weight titanium dioxide relative to the weight of the paint composition.

59. The composition of claim 52, wherein the coating composition comprises less than about 6% by weight titanium dioxide relative to the weight of the paint composition.

60. The composition of claim 52, wherein the coating composition comprises less than about 4% by weight titanium dioxide relative to the weight of the paint composition.

61. The composition of claim 52, wherein the coating composition comprises less than about 2% by weight titanium dioxide relative to the weight of the paint composition.

62. The composition of claim 52, wherein the kaolin has a d₉₀ of less than 5 microns

63. The composition of claim 52, wherein the kaolin has a d₉₀ of less than 2 microns.

64. The composition of claim 52, wherein the kaolin has a d₅₀ of less than 1 micron.

65. The composition of claim 52, wherein the kaolin has a d₅₀ less than 0.5 micron.

66. The composition of claim 52, wherein the alkaline earth metal carbonate has a d₉₀ of less than 5 microns.

67. The composition of claim 52, wherein the alkaline earth metal carbonate has a d₉₀ of less than 2 microns.

68. The composition of claim 52, wherein the alkaline earth metal carbonate has a d₅₀ of less than 1 micron.

69. The composition of claim 52, wherein the alkaline earth metal carbonate has a d₅₀ less than 0.5 micron.

70. The composition of claim 52, wherein the alkaline earth metal carbonate has a steepness ranging from 20 to 80.

71. The composition of claim 52, wherein the alkaline earth metal carbonate has a steepness ranging from 20 to 40.

72. The composition of claim 52, wherein a volume concentration ratio of kaolin to alkaline earth metal carbonate ranges between 0.7:1 and 5:1.

73. The composition of claim 52 wherein a volume concentration ratio of kaolin to alkaline earth metal carbonate ranges between 1:1 and 3:1.

74. A method for improving opacity of a coating composition, the method comprising:
adding kaolin and alkaline earth metal carbonate to the coating composition,
wherein the kaolin has a d₅₀ of not more than 2 microns, the alkaline earth metal carbonate has a d₅₀ of not more than 2 microns, and the coating composition comprises not more than 10% by weight titanium dioxide relative to the weight of the coating composition.

75. A method for reducing titanium dioxide content of a coating composition and at least substantially maintaining opacity of the coating, the method comprising:
adding fine kaolin and fine alkaline earth metal carbonate to the coating composition,
wherein a volume concentration ratio of the fine kaolin to the fine alkaline earth metal carbonate ranges between 0.5:1 and 10:1.
